(19) United States
(12) Patent Application Publication
(10) Pub. No.: US 2003/0048945 A1
(43) Pub. Date: Mar. 13, 2003

(54) Image output system management method

(75) Inventor: Kiyomi Tamagawa, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/218,901

(22) Filed: Aug. 15, 2002

(30) Foreign Application Priority Data
Aug. 20, 2001 (JP) 2001-249308

(51) Int. Cl. G06K 9/00

(52) U.S. Cl. 382/167

(57) ABSTRACT

In order to cancel an instrumental error between calorimeters 13 and 23, a target value 25 is altered by the corresponding instrumental error. And in order to cancel an overlap of residues of calibrations, the target value 25 is altered by the corresponding residue occurred on the first image output system 10.

### BACKGROUND OF THE INVENTION

1. Field of the Invention

The present invention relates to an image output system management method of managing colors of an image in an image output system for outputting images.

2. Description of the Related Art

Hitherto, when a color printing machine is used to perform a color image printing, there is performed, prior to performing the printing, such a matter that a color printer and the like is used to create a proof image of which a color is closely similar to a color of an image to be printed by the color printing machine. A printing system, in which a color printing machine is used to perform a color image printing in accordance with image data, and a proof system, in which a color printer is used to create a proof image, are referred to as an image output system in such a meaning that an image is outputted in accordance with image data.

When a printer is used to create a proof image, it is general that the proof image is created in accordance with such a way that a printing profile describing a relation between image data and a color of an actual printed matter, which is associated with a sort of a printing machine of interest and using conditions (a sort of inks to be used, paper quality of papers to be printed, etc.) for the printing machine, and a printer profile describing a relation between image data and a color of an image to be actually printed out, which is associated with a sort of a printer of interest and using conditions for the printer, are notified; the image data for printing is converted into the image data for a printer in accordance with the printing profile and the printer profile; and the proof image is created in accordance with the converted image data for a printer. Creation of the proof image according to this scheme makes it possible to create a proof image, which is coincident with the actual printed matter in color in some extent. Usually, a printing profile associated with the typical using conditions is provided from a printer, and a printer profile is provided from a maker of printers.

However, even if a proof image, which is sufficiently coincident with an image obtained through the actual printing in color, can be created in such a manner that a printing profile and a printer profile are obtained or created so that a color conversion is performed in accordance with the printing profile and the printer profile, it happens that the proof image is not coincident with the image obtained through the actual printing in color owing to a compound of various main causes of changes and errors occurring with the passage of time. In order to correct such a discordance of color there is proposed a technology called a calibration of contributing to an improvement of a coincidence in color between those images.

According to such a calibration, the improvement of a coincidence in color between those images is implemented in accordance with the procedure as set forth below.

(1) There are prepared calibration chart data representative of a calibration use tone chart (calib-chart) consisting of a plurality of patches, and in addition target values of colors of the plurality of patches constituting the calib-chart wherein the calib-chart is outputted by an image output system in accordance with the calibration chart data. As the target values, for example, if an object of the calibration is a proof system, when the proof system creates a proof image which is coincident in color with an image on the printed matter, the calib-chart is outputted in accordance with the calibration chart data, and colorimetric values, which are obtained through measurement of colors of the patches of the calib-chart by a colorimeter, are adopted as the target values. Hereinafter, the explanation will be continued assuming that the object of the calibration is a proof system.

(2) When the calibration is needed, the proof system outputs the calib-chart, so that the colors of the patches of the calib-chart are measured by the calorimeter to obtain the colorimetric values. Further, there are obtained residue of the calorimetric values to the target values.

(3) If the residue of the colorimetric values to the target values is within a predetermined convergence target range (a range of an allowable error), the process terminates. If the residue of the calorimetric values to the target values is out of the convergence target range, the printer profile is used to determine values of image data associated with the calorimetric values.

(4) The calibration table, which is incorporated into the output side as a part of the printer file, is corrected so as to cancel a difference between the value of the image data determined in the above-step (3) and the value of the calibration chart data prepared in the above-step (1). The calibration table is a one-dimensional LUT (Look Up Table), which is created on each of C, M, Y, K, if the image data in the proof system is CMYK data, for instance. The image data converted by the calibration table is fed to the printer. Thereafter, the process returns to the above-step (2) to repeat the above-mentioned procedure.

While the above-explanation is made assuming that the calibration is performed in the proof system, it is acceptable the calibration is performed in the printing system.

When the calibration is performed in each of the image output systems, it is possible to improve coincidence of colors between images even a case where change with elapse occurs on the image output systems and whereby discordance of colors occurs among the image output systems.

However, in the event that a plurality of image output systems is located geographically apart from one another, calorimeters are prepared for each of the image output systems. Thus, instrumental errors exist on colorimetric values among the colorimeters, and as a result, it would happen that discordance of colors occurs owing to influence of the discordance on the calibration.

Further, in the event that the calibration is executed in each of a plurality of image output systems, even if the residue of the calorimetric values to the target values is within a predetermined convergence target range in each of the image output systems, a direction of the residue will be varied on each of the image output systems. Thus, it would happen that residues overlap among a plurality of image output systems, and the difference between colors of the images is out of the convergence target range (a range of an allowable error).

### SUMMARY OF THE INVENTION

In view of the foregoing, it is an object of the present invention to provide an image output system management method capable of obtaining coincidence of colors of images among a plurality of image output systems with greater accuracy.

To achieve the above-mentioned object, the present invention provides a first image output system management method of obtaining coincidence among colors of images outputted by a plurality of image output systems for outputting images in accordance with image data,

wherein each of said image output systems outputs an image corrected in color in accordance with a correction function set up, and has a calorimeter for measuring a color of the outputted image to obtain a calorimetric value, wherein said correction function is set up in such a manner that the calorimetric value, in which an image is outputted in accordance with a predetermined image data for the associated image output system and said colorimeter is used to measure the image, is coincident with a target value set up within a tolerable error, said image output system management method comprising:

a first colorimetry step of measuring a color of a predetermined image using a colorimeter provided on a first image output system of said plurality of image output systems to obtain a calorimetric value;

a second colorimetry step of measuring a color of an image having the same color as the predetermined image using a calorimeter provided on a second image output system of said plurality of image output systems to obtain a calorimetric value; and

a first target value alteration step of altering and setting up over again the target value in the second image output system by a corresponding difference between the calorimetric value obtained in said second colorimetry step and the calorimetric value obtained in said first colorimetry step.

According to the first image output system management method of the present invention, an alteration and setting up of the target value in the first target value alteration step makes it possible to cancel instrumental errors between calorimeters and thereby contributing to an improvement of the coincidence of colors. Thus, according to the first image output system management method of the present invention, it is possible to implement the coincidence of colors with greater accuracy.

In the first image output system management method according to the present invention as mentioned above, it is preferable that in each of said plurality of image output systems, there is adopted, as the predetermined image data, chart data representative of a reference chart constituted of a predetermined plurality of patches, and there is set up, as the target value, a plurality of target values associated with the plurality of patches,

said first colorimetry step and said second colorimetry step are a step in which the same chart as the reference chart is measured for each patch to obtain a calorimetric value on each patch, and

said first target value alteration step is a step in which the plurality of target values is set up over again.

According to the first image output system management method as mentioned above, the target value on each patch is set up and the calibration is performed. This feature guarantees the coincidence of colors of an image over a wide range on a color space.

Further, in the first image output system management method according to the present invention as mentioned above, it is acceptable that in each of said plurality of image output systems, there is adopted, as the predetermined image data, image data representative of an image common to the plurality of image output systems,

said first colorimetry step and said second colorimetry step are a step in which the same image as the common image is measured to obtain a calorimetric value, and

said first target value alteration step sets up over again the target value in the second image output system to a value corresponding to a value in which a difference between the target value in the first image output system and the colorimetric value obtained through the first colorimetry step is added to the calorimetric value obtained through the second colorimetry step.

To achieve the above-mentioned object, the present invention provides a second image output system management method of obtaining coincidence among colors of images outputted by a plurality of image output systems for outputting images in accordance with image data,

wherein each of said image output systems outputs an image corrected in color in accordance with a correction function set up, and has a colorimeter for measuring a color of the outputted image to obtain a calorimetric value, wherein said correction function is set up in such a manner that the calorimetric value, in which an image is outputted in accordance with a predetermined image data for the associated image output system and said colorimeter is used to measure the image, is coincident with a target value set up within a tolerable error, said image output system management method comprising:

a third colorimetry step of outputting an image in accordance with a predetermined image data in a first image output system of said plurality of image output systems and of measuring a color of the image outputted using a calorimeter provided on the first image output system to obtain a calorimetric value; and

a second target value alteration step of altering and setting up over again the target value in a second image output system of said plurality of image output systems in accordance with a residue wherein the target value in the first image output system is subtracted from the calorimetric value obtained in said third colorimetry step.

In the second image output system management method according to the present invention as mentioned above, it is acceptable that said image output system management method further comprises a fourth colorimetry step of outputting an image in accordance with the same image data as the predetermined image data in the second image output system of said plurality of image output systems and of measuring a color of the image outputted using a calorimeter provided on the second image output system to obtain a calorimetric value, and

wherein said second target value alteration step alters and sets up over again the target value in the second image output system by a corresponding whole or part of a difference between a first residue wherein the target value in the first image output system is subtracted from the calorimetric value obtained in said third colorimetry step and a second residue wherein the target value in the second image output system is subtracted from the colorimetric value obtained in said fourth colorimetry step.

According to the second image output system management method of the present invention, an alteration of the target value in the second target value alteration step makes it possible to cancel an overlap of residues of calibration. Thus, according to the second image output system management method of the present invention, it is possible to implement the coincidence of colors of images among a plurality of image output systems with greater accuracy.

In the second image output system management method according to the present invention as mentioned above, it is preferable that in each of said plurality of image output systems, there is adopted, as the predetermined image data, chart data representative of a reference chart constituted of a predetermined plurality of patches, and there is set up, as the target value, a plurality of target values associated with the plurality of patches,

said third colorimetry step and said fourth colorimetry step are a step in which the same chart as the reference chart is measured for each patch to obtain a calorimetric value on each patch, and

said second target value alteration step is a step in which the plurality of target values is set up over again.

According to the second image output system management method as mentioned above, the target value on each patch is set up and the calibration is performed. This feature guarantees the coincidence of colors of an image over a wide range of a color space.

In the second image output system management method according to the present invention as mentioned above, it is preferable that said second target value alteration step sets up over again the target values in the event that a difference between the first residue and the second residue exceeds the tolerable value.

In the event that a difference between the first residue and the second residue does not exceed the tolerable value, no discordance of colors of an image due to the overlap of residues occurs. It would be better to maintain the target values as they are, so that troubles may be avoided.

In the second image output system management method according to the present invention as mentioned above, it is preferable that said second target value alteration step alters and sets up over again the target value in the second image output system by a corresponding first residue.

When the target value is altered, there is a possibility that a direction of the residue is also altered. Thus, it is not always the best that the target value is altered by the value corresponding to the whole of the difference in which the second residue is subtracted from the first residue. In the event that the target value is altered by the corresponding first residue, the target value after the alteration is representative of a color of the output image in the first image output system. Thus, a color of the output image in the second image output system is always within the tolerable error with respect to the output image in the first image output system through the calibration. Accordingly, it is possible to always guarantee a coincidence of colors of an image.

### BRIEF DESCRIPTION OF THE DRAWINGS

FIG. 1 is a view of an image output system in which colors of images are managed in accordance with an embodiment of an image output system management method according to the present invention.

FIG. 2 is a conceptual view of a calibration table created through the general calibration.

FIG. 3 is a view useful for understanding an image output system management method of canceling overlap of errors.

FIG. 4 is a view useful for understanding an effect to set up over again a target value.

### DETAILED DESCRIPTION OF PREFERRED EMBODIMENTS

Embodiments of the present invention will be described with reference to the accompanying drawings.

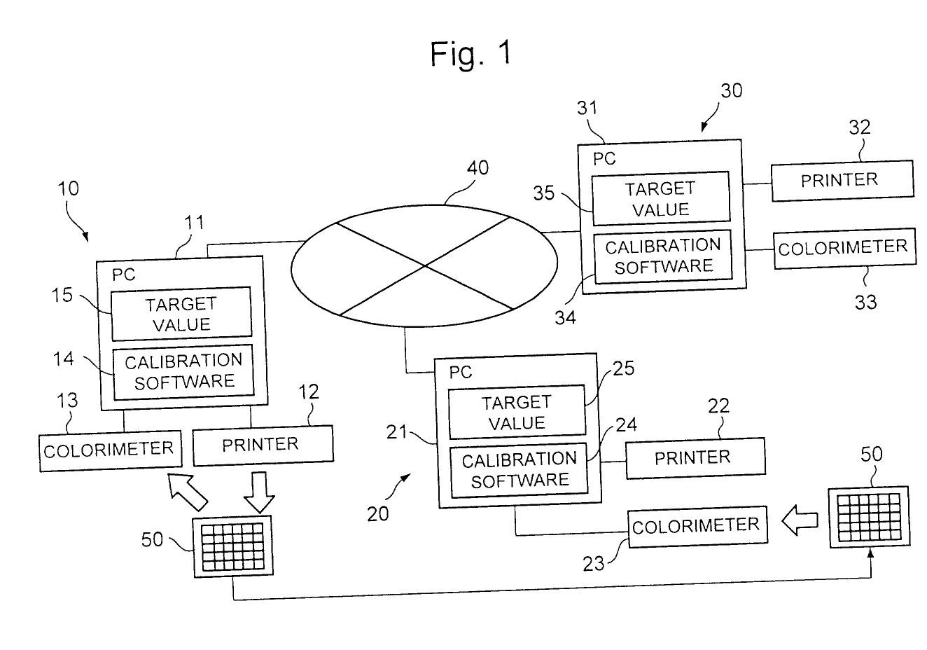

FIG. 1 is a view of an image output system in which colors of images are managed in accordance with an embodiment of an image output system management method according to the present invention.

FIG. 1 exemplarily shows three image output systems 10, 20 and 30, which are mutually connected via a communication network 40.

The image output systems 10, 20 and 30 have personal computers (PC) 11, 21 and 31, respectively. Connected to the personal computers (PC) 11, 21 and 31 are printers 12, 22 and 32 and calorimeters 13, 23 and 33, respectively. The image output systems 10, 20 and 30 output images through the printers 12, 22 and 32 in accordance with image data received by the personal computers (PC) 11, 21 and 31 and image data created by the personal computers (PC) 11, 21 and 31, respectively. The outputted images are measured by the calorimeters 13, 23 and 33, respectively, as an occasion arises. The calorimeters 13, 23 and 33 output, as colorimetric values, for example, XYZ chromaticity values.

Installed in the personal computers (PC) 11, 21 and 31 are calibration software 14, 24 and 34, respectively. When the calibration software 14, 24 and 34 are executed, the above-mentioned calibrations are performed, so that colors of the output images are converged to colors represented by target values 15, 25 and 35 set up beforehand, respectively. Here, it is assumed that the image output systems 10, 20 and 30 each register beforehand common chart data representative of a reference color chart constituted by N pieces of color patch, and prepare N pieces of target value associated with the N pieces of color patch, as the target values 15, 25 and 35, respectively.

The calibration is performed in accordance with the XYZ chromaticity values outputted from the calorimeters 13, 23 and 33 connected to the personal computers (PC) 11, 21 and 31, respectively. However, there exist instrumental errors among the XYZ chromaticity values outputted from the calorimeters 13, 23 and 33. Thus, as a result of the calibration executed by the image output systems 10, 20 and 30, there occurs a discordance of colors of images due to the instrumental errors among the image output systems 10, 20 and 30.

Hereinafter, there will be explained an image output system management method of canceling such instrumental errors. While it is possible to optionally decide a reference image output system from among the three image output systems, in the following explanation, it is assumed that the first image output system 10 is used as the reference, and the second image output system 20 is subject to the reference. Further, it is assumed that the image output systems 10 and 20 have been subjected to the calibration beforehand.

The image output system management method of canceling such instrumental errors is executed in accordance with, for example, the following procedure.

(1_{—}1) The reference image output system (the first image output system 10) outputs a color chart 50 using the common chart data.

(1_{—}2) The N pieces of color patch, which constitute the color chart 50, are measured by a colorimeter 13 to obtain N sets of XYZ chromaticity values (X′i, Y′i, Z′i) (i=1, . . . , N).

(1_{—}3) Color differences (dX′i, dY′i, dZ′i) (i=1, . . . , N) between N sets of target values (X0i, Y0i, Z0i) (i=1, . . . , N) associated with the N pieces of color patch and the N sets of XYZ chromaticity values (X′i, Y′i, Z′i) (i=1, . . . , N) obtained in the above step (1_{—}2) are computed in accordance with the following formulas.

dX′i=X′I−X0i

dY′i=Y′i−Y0i

dZ′i=Z′i−Z0I

(1_{—}4) The color chart 50 outputted in the above step (1_{—}1) and the color differences (dX′i, dY′i, dZ′i) (i=1, . . . , N) computed in the above step (1_{—}3) are transferred to the second image output system 20.

(1_{—}5) The colorimeter 23 of the second image output system 20 is used to measure the N pieces of color patch, which constitute the color chart 50, so that N sets of XYZ chromaticity values (X″i, Y″i, Z″i) (i=1, . . . , N).

(1_{—}6) The target values in the second image output system 20 are set up over again to (X″i−dX′i, Y″i−dY′i, Z″i−dZ′i) (i=1, . . . , N).

The target values (X″i−dX′i, Y″i−dY′i, Z″i−dZ′i) (i=1, . . . , N), which are set up over again in the process of the step (1_{—}6), has the same meaning as that the target values are altered by the corresponding instrumental error (Z″i−Z′i) of the colorimeter, when the target values (X″i−dX′i, Y″i−dY′i, Z″i−dZ′i) (i=1, . . . , N) are analyzed in accordance with the following equations.

X″i−dX′i=X″i−(X′i−X0i)=X0i+(X″i−X′i)

Y″i−dY′i=Y″i−(Y′i−Y0i)=Y0i+(Y″i−Y′i)

Z″i−dZ′i=Z″i−(Z′i−Z0i)=Z0i+(Z″i−X′i)

In effect, according to the image output system having a calorimeter outputting for example higher output values than an output value of a reference colorimeter, the target value is set up higher over again. Executing the calibration again through setting up the target value over again makes it possible to cancel the instrumental error of the colorimeter so that the actual color of the output image is coincident with the color of the output image in the reference image output system.

According to the procedure of the step (1_{—}1) to the step (1_{—}6), the color differences (dX′i, dY′i, dZ′i) (i=1, . . . , N) are computed and transferred. However, according to an image output system management method of the present invention, it is acceptable that the XYZ chromaticity values (X′i, Y′i, Z′i) (i=1, . . . , N), which are obtained through the step (1_{—}2), are transferred per se. Further, according to an image output system management method of the present invention, it is acceptable that an output of the color chart 50 using the common chart data in the step (1_{—}1) is replaced by an output of the color chart using another chart data, or alternatively the appropriation of ready-made color chart. Furthermore, according to an image output system management method of the present invention, it is acceptable that the use of the color chart is replaced by the use of optional images capable of being measured by a calorimeter.

By the way, it is ideal that the color differences (dX′i, dY′i, dZ′i) (i=1, . . . , N) are, of course, completely near 0. As will be explained hereinafter, however, when details of the general calibration are scrutinized, it is unavoidable that a color difference remains in somewhat.

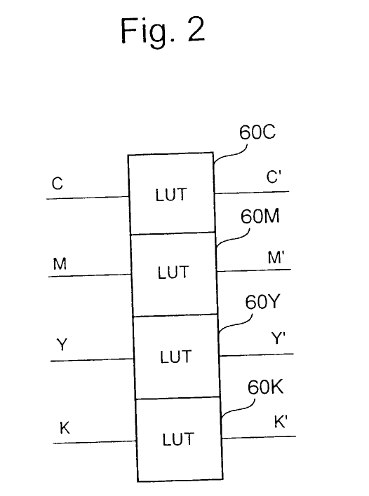

FIG. 2 is a conceptual view of a calibration table created through the general calibration.

FIG. 2 shows calibration tables, which are created in the event that image data is CMYK data, wherein four one-dimensional LUT format of calibration tables 60C, 60M, 60Y and 60K, which correspond to C, M, Y and K, respectively, are created.

The calibration tables 60C, 60M, 60Y and 60K constitute a part of a printer profile describing a relation between image data on a printer provided on an image output system and a color of an image to be actually printed out, and are incorporated into an output side of the printer profile. In the printer profile, before the calibration tables 60C, 60M, 60Y and 60K, values (for example chromaticity values) representative of colors of an image are converted into image data (here CMYK data), and the CMYK data after the conversion are fed to the calibration tables 60C, 60M, 60Y and 60K. The calibration tables 60C, 60M, 60Y and 60K correct components of CMYK data (C, M, Y, K) and output CMYK data (C′, M′, Y′, K′) after the correction. The outputted CMYK data (C′, M′, Y′, K′) are fed to a printer so that an image is created in accordance with the CMYK data (C′, M′, Y′, K′).

In the calibration, the calibration tables 60C, 60M, 60Y and 60K are created over again so that a color to be created in the printer approaches a target color represented by the target value. A correction quantity of correcting the calibration tables is determined through a computation in accordance with a difference between a colorimetric value of the calibration chart created by the printer and the target value. However, there is discrepancy somewhat between the correction quantity determined through the computation and a correction quantity actually necessary. Thus, the discrepancy causes a color difference. Further, there would occur also a color difference caused by a calorimeter for measuring a color of an image and a reproduction error of a printer for outputting an image. In view of the foregoing, there is set up a range of errors (color differences), which is permissible from a viewpoint of technology and a viewpoint of visual sensation, so that a calibration is performed in such a manner that a color of an image to the target value is within the range of errors.

It cannot be estimated as to a direction on a color space wherein such errors caused by the calibration occur. Thus, an overlap of errors occurs among a plurality of image output systems, and as a result, it would happens that a discordance of colors of an image occurs in such an extent that it is not permissible from a viewpoint of visible sensation.

Hereinafter, there will be explained an image output system management method of canceling the overlap of errors.

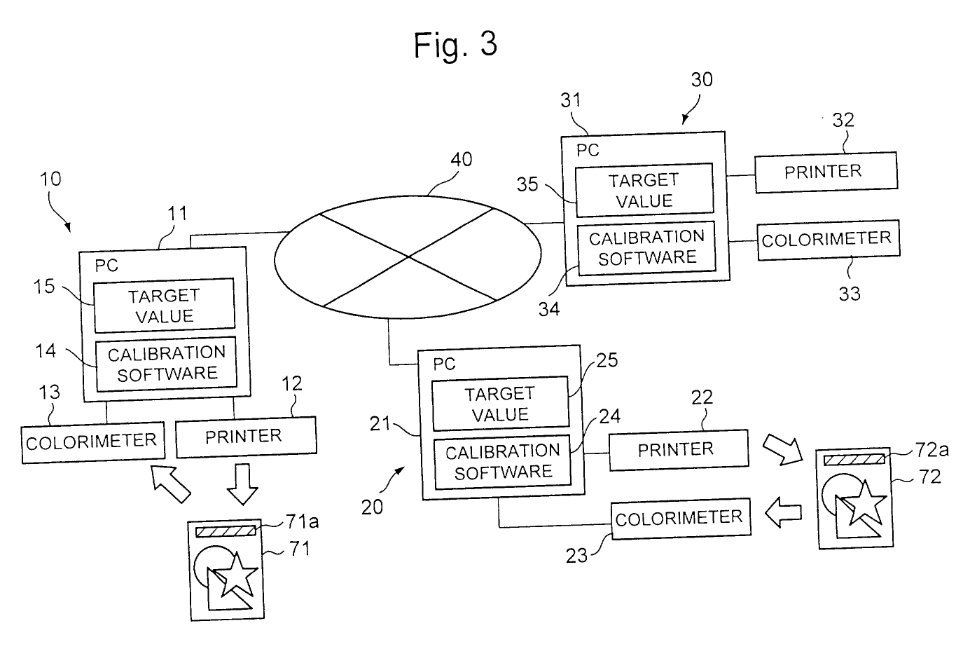

FIG. 3 is a view useful for understanding an image output system management method of canceling overlap of errors.

FIG. 3 also shows three image output systems 10, 20 and 30, which are mutually connected via a communication network 40, as also shown in FIG. 1. In FIG. 3, the same reference numbers as those of FIG. 1 denote the same parts. Also here it is assumed that the first image output system 10 is used as the reference, and the second image output system 20 is subject to the reference.

The image output system management method of canceling such an overlap of errors is executed in accordance with, for example, the following procedure.

(2_{—}1) In the reference image output system (the first image output system 10) side, a printer 12 outputs an image 71 including a gray chart consisting of gray tone patches 71a, and it is confirmed that a color of the image 71 is a desired color.

(2_{—}2) The calorimeter 13 of the first image output system 10 is used to measure the tone patches 71a, and the residues (dX′, dY′, dZ′) as to the target value associated with the tone patches 71a are computed.

(2_{—}3) Image data used when the printer 12 outputs the image 71, and the residues (dX′, dY′, dZ′) computed in the step (2_{—}2) are transferred to the second image output system 20.

(2_{—}4) The printer 22 of the second image output system 20 outputs an image 72 including a gray chart consisting of gray tone patches 72a, using the image data transferred.

(2_{—}5) The calorimeter 23 of the second image output system 20 is used to measure the tone patches 72a, and the residues (dX″, dY″, dZ″) as to the target value associated with the tone patches 72a are computed.

(2_{—}6) The residues (dX′, dY′, dZ′) are compared with the residues (dX″, dY″, dZ″). In the event that a difference between the residues exceeds a tolerable error of the calibration, the target value of the second image output system 20 is altered by the corresponding residues (dX″, dY″, dZ″) transferred from the first image output system 10 and is set up over again.

When the calibration in the second image output system 20 is executed again in accordance with the target value set up over again in the above-mentioned image output system management method, it is possible to obtain a coincidence in color of an image between the first image output system 10 and the second image output system 20 with greater accuracy.

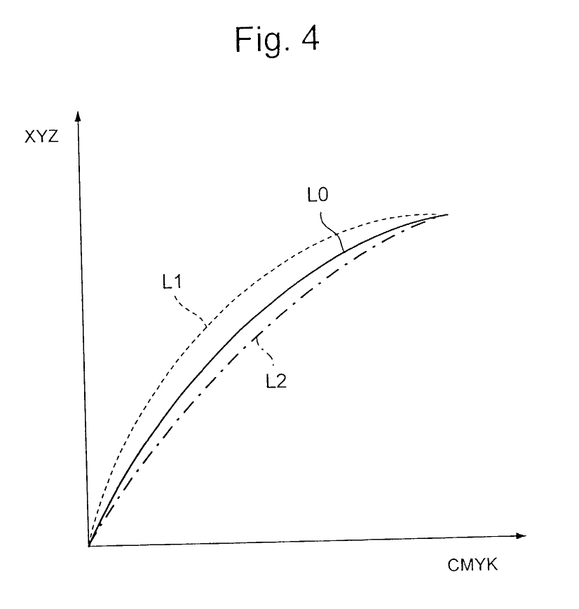

FIG. 4 is a view useful for understanding an effect to set up over again a target value.

A horizontal axis of a graph shown in FIG. 4 conceptually denotes CMYK data representative of the above-mentioned gray tone patches on a one-dimensional basis. A vertical axis of the graph conceptually denotes chromaticity values representative of colors of the gray tone patches outputted in accordance with the CMYK data on a one-dimensional basis.

A solid line L0 in the graph shown in FIG. 4 denotes target values associated with the gray tone patches. A dotted line L1 denotes chromaticity values of the tone patches actually outputted in the first image output system 10. A dashed line L2 denotes chromaticity values of the tone patches actually outputted in the second image output system 20.

While the chromaticity values represented by the dotted line L1 and the dashed line L2 are within the tolerable errors with respect to the target value represented by the solid line L0, as shown in FIG. 4, in the event that the directions of the errors are mutually opposite, it happens that a difference between the chromaticity values represented by the dotted line L1 and the dashed line L2 exceeds the tolerable error.

In order to cancel the difference of the chromaticity values, simply, it is considered that the target value represented by the solid line L0 is varied by the corresponding part or whole of the difference of the chromaticity values. That is, it is considered that when the target value is altered and the calibration is executed again, the dashed line L2 moves to the dotted line L1 side by the corresponding alteration of the target value, so that a difference between the chromaticity values represented by the dashed line L2 and the dotted line L1 is reduced.

According to this concept, an alteration of the target value by the value corresponding to the whole of the difference between the chromaticity values represented by the dashed line L2 and the dotted line L1 makes it possible that the difference between the chromaticity values disappears.

However, in the event that the calibration is executed again, a relation between the solid line L0 and the dashed line L2 is not always maintained, and there is a possibility that the dashed line L2 moves to the same side as the dotted line L1 with respect to the solid line L0. For this reason, it is preferable that the target value is altered so that the solid line L0 is coincident to the dotted line L1. Thus, when the target value is altered and the calibration is executed again, the dashed line L2 is surely converged within the tolerable error with respect to the dotted line L1, and thereby guaranteeing the coincidence of colors of an image between the first image output system and the second image output system.

According to the procedure of the step (2_{—}1) to the step (2_{—}6), while the image including the gray tone patches is outputted, it is acceptable that an arbitrary image, in which the residue for the target value can be determined, is outputted instead.

Further, according to the procedure of the step (2_{—}1) to the step (2_{—}6), the target value is set up over again in the event that the difference between the residues exceeds the tolerable error. According to the present invention, however, it is acceptable that the target value is set up over again always in accordance with the residue in the first image output system, without comparison between the residues. In this case, there are no need of transmission of the image data and colorimetry of the tone patches in the second image output system side.

In the calibration in the procedure of the step (1_{—}1) to the step (1_{—}6) and the procedure of the step (2_{—}1) to the step (2_{—}6), components of C, M, Y and K are dealt with on equal terms, and the associated calibration tables are created. According to the present invention, however, in view of the fact that CMY are main factors in color balance of the gray, it is acceptable that set up of the correction function referred to in the present invention is an easy calibration in which only calibration tables of three components of C, M and Y are simply created over again. Or alternatively, according to the present invention, it is acceptable that set up of the correction function referred to in the present invention is a combination of an easy calibration in which only calibration tables of three components of C, M and Y are simply created over again with a calibration of K-form plate alone.

As mentioned above, according to an image output system management method of the present invention, it is possible to obtain coincidence of colors of images among a plurality of image output systems with greater accuracy.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. An image output system management method of obtaining coincidence among colors of images outputted by a plurality of image output systems for outputting images in accordance with image data,
wherein each of said image output systems outputs an image corrected in color in accordance with a correction function set up, and has a colorimeter for measuring a color of the outputted image to obtain a calorimetric value, wherein said correction function is set up in such a manner that the calorimetric value, in which an image is outputted in accordance with a predetermined image data for the associated image output system and said calorimeter is used to measure the image, is coincident with a target value set up within a tolerable error, said image output system management method comprising:
a first colorimetry step of measuring a color of a predetermined image using a calorimeter provided on a first image output system of said plurality of image output systems to obtain a calorimetric value;
a second colorimetry step of measuring a color of an image having the same color as the predetermined image using a calorimeter provided on a second image output system of said plurality of image output systems to obtain a calorimetric value; and
a first target value alteration step of altering and setting up over again the target value in the second image output system by a corresponding difference between the calorimetric value obtained in said second colorimetry step and the colorimetric value obtained in said first colorimetry step.

2. An image output system management method according to claim 1, wherein in each of said plurality of image output systems, there is adopted, as the predetermined image data, chart data representative of a reference chart constituted of a predetermined plurality of patches, and there is set up, as the target value, a plurality of target values associated with the plurality of patches,
said first colorimetry step and said second colorimetry step are a step in which the same chart as the reference chart is measured for each patch to obtain a calorimetric value on each patch, and
said first target value alteration step is a step in which the plurality of target values is set up over again.

3. An image output system management method according to claim 1, wherein in each of said plurality of image output systems, there is adopted, as the predetermined image data, image data representative of an image common to the plurality of image output systems,
said first colorimetry step and said second colorimetry step are a step in which the same image as the common image is measured to obtain a calorimetric value, and
said first target value alteration step sets up over again the target value in the second image output system to a value corresponding to a value in which a difference between the target value in the first image output system and the calorimetric value obtained through the first colorimetry step is added to the colorimetric value obtained through the second colorimetry step.

4. An image output system management method of obtaining coincidence among colors of images outputted by a plurality of image output systems for outputting images in accordance with image data,
wherein each of said image output systems outputs an image corrected in color in accordance with a correction function set up, and has a colorimeter for measuring a color of the outputted image to obtain a calorimetric value, wherein said correction function is set up in such a manner that the colorimetric value, in which an image is outputted in accordance with a predetermined image data for the associated image output system and said calorimeter is used to measure the image, is coincident with a target value set up within a tolerable error, said image output system management method comprising:
a third colorimetry step of outputting an image in accordance with a predetermined image data in a first image output system of said plurality of image output systems and of measuring a color of the image outputted using a colorimeter provided on the first image output system to obtain a calorimetric value; and
a second target value alteration step of altering and setting up over again the target value in a second image output system of said plurality of image output systems in accordance with a residue wherein the target value in the first image output system is subtracted from the calorimetric value obtained in said third colorimetry step.

5. An image output system management method according to claim 4, wherein said image output system management method further comprises a fourth colorimetry step of outputting an image in accordance with the same image data as the predetermined image data in the second image output system of said plurality of image output systems and of measuring a color of the image outputted using a colorimeter provided on the second image output system to obtain a calorimetric value, and
wherein said second target value alteration step alters and sets up over again the target value in the second image output system by a corresponding whole or part of a difference between a first residue wherein the target value in the first image output system is subtracted from the calorimetric value obtained in said third colorimetry step and a second residue wherein the target value in the second image output system is subtracted from the colorimetric value obtained in said fourth colorimetry step.

6. An image output system management method according to claim 5, wherein in each of said plurality of image output systems, there is adopted, as the predetermined image data, chart data representative of a reference chart constituted of a predetermined plurality of patches, and there is set up, as the target value, a plurality of target values associated with the plurality of patches,
said third colorimetry step and said fourth colorimetry step are a step in which the same chart as the reference chart is measured for each patch to obtain a calorimetric value on each patch, and
said second target value alteration step is a step in which the plurality of target values is set up over again.

7. An image output system management method according to claim 4, wherein said second target value alteration step sets up over again the target values in the event that a difference between the first residue and the second residue exceeds the tolerable value.

8. An image output system management method according to claim 4, wherein said second target value alteration step alters and sets up over again the target value in the second image output system by a corresponding first residue.

9. An image output system management method according to claim 5, wherein said second target value alteration step alters and sets up over again the target value in the second image output system by a corresponding first residue.
